(19) United States
(12) Patent Application Publication
(10) Pub. No.: US 2008/0239711 A1
(43) Pub. Date: Oct. 2, 2008

(54) Military Lantern

(76) Inventor: Chan-bok Seok, Gyeonggi-do (KR)

Correspondence Address: DILWORTH & BARRESE, LLP, 333 EARLE OVINGTON BLVD., SUITE 702, UNIONDALE, NY, 11553, US

(21) Appl. No.: 10/592,923

(22) PCT Filed: Mar. 16, 2005
(86) PCT No.: PCT/KR2005/000752

§ 371 Date: Sep. 14, 2006

(30) Foreign Application Priority Data
Mar. 17, 2004 (KR) 20-2004-0007374

(51) Int. Cl. F21L 4/00

(52) U.S. Cl. 362/157

(57) ABSTRACT

Disclosed herein is a military lantern, which includes a body formed in a rectangular shape and having a power source buried therein, an electric bulb and a reflection mirror disposed at right angles to the body, a plurality of color filters used for sending a hand signal, and a color filter keeping case mounted on the front surface of the body, thereby reducing the entire size and weight in comparison with the conventional military lantern, and allowing a user to easily manipulate a hand signal.

### TECHNICAL FIELD

The present invention relates to a military lantern, and more particularly, to a military lantern, which includes a hexahedral body having a power source buried therein and a filter keeping case mounted on the front surface of the body, thereby providing convenience in carrying and allowing a user to easily manipulate a hand signal for communication during night military operations.

### BACKGROUND ART

In general, differently from a general portable flashlight, a military lantern includes color filters of various colors for communicating with others by a hand signal during night military operations, a body part in which a power source is buried for providing convenience in signal manipulation, and an illumination part having an electric bulb and a reflection mirror, wherein the body part and the illumination part are arranged at right angles to each other. The color filter is formed of a disc type semitransparent body. When the lantern is used for the purpose of sending the hand signal, the filter of a wanted color is mounted in front of the electric bulb and the reflection mirror, and a switch is manipulated. On the other hand, when the lantern is used as a general illuminator, the color filters are kept in a keeping case separately mounted on a part of the body.

However, in the conventional military lantern, the filter keeping case is disposed in the lower end of the body in which the power source is buried. Therefore, the body must be formed in a cylindrical shape like the color filter, and it is structurally difficult to reduce a diameter of the body due to a limited structure of the color filter. So, the conventional military lantern is very large in volume and heavy.

Recently, according to the current trend of lightness and miniaturization of military equipments, also the diameter of the cylindrical body of the military lantern is gradually reduced, but, in this case, the size of the color filter and the reflection mirror must also be reduced. Then, the military lantern may have deteriorated illumination function and signal sending function.

### DISCLOSURE OF INVENTION

### Technical Problem

Accordingly, the present invention has been made in view of the above problems occurring in the prior art, and it is an object of the present invention to provide a military lantern, which includes a body formed in a rectangular solid shape and having a power source buried therein, an electric bulb and a reflection mirror disposed at right angles to the body, a plurality of color filters used for sending a hand signal, and a color filter keeping case mounted on the front surface of the body, thereby reducing the entire size and weight in comparison with the conventional military lantern, and allowing a user to easily manipulate a hand signal.

### Technical Solution

To achieve the above object, according to the invention, there is provided a military lantern including: a body formed in a rectangular solid shape and having a power source buried therein; an electric bulb, a reflection mirror and an outer lid mounted on the upper end portion of the body in a perpendicular direction to the body; at least one switch mounted on the upper right side or the upper left side of the body; a lower lid mounted on the lower end of the body; a cylindrical filter keeping case mounted on the front surface of the body; and a plurality of color filters contained inside the filter keeping case.

Furthermore, the lower lid is connected with the body by rotation of a rotational locking member, and an conducting latch member connected to the rotational locking member connects an electric wire with the power source, the electric wire being connected to the electric bulb.

Moreover, an inner transparent lid is mounted between the reflection mirror and the outer lid.

Additionally, a plurality of satellite LED bulbs are mounted around the electric bulb.

In addition, a spare bulb keeping recess is formed on the upper end of the inside of the body.

### BRIEF DESCRIPTION OF THE DRAWINGS

FIG. 1 is a perspective view of a military lantern according to a preferred embodiment of the present invention.

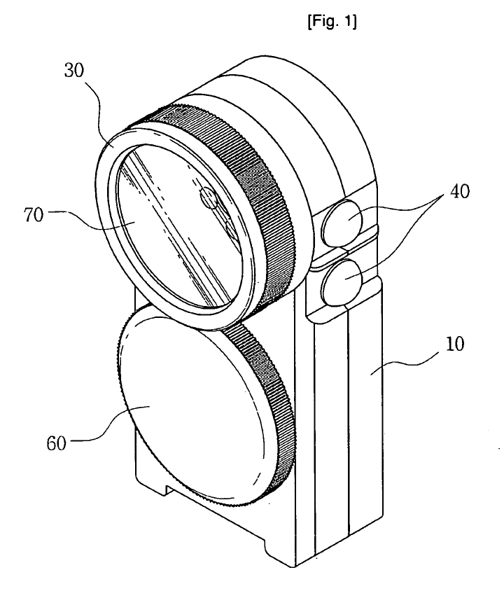

FIG. 2 is an exploded side-sectional view showing a state where an outer lid, a lower lid and a filter cover are respectively separated.

FIG. 3 is a side-sectional view showing a used state of the military lantern according to the present invention.

### BEST MODE FOR CARRYING OUT THE INVENTION

A military lantern according to the present invention includes: a body 10 having a power source 100 buried therein; an electric bulb 20, a reflection mirror 22 and an outer lid 30 mounted on the upper end portion of the body 10 in a perpendicular direction to the body 10; at least one switch 40 mounted on the upper right side or the upper left side of the body 10; a lower lid 50 mounted on the lower end of the body 10; a cylindrical filter keeping case 60 mounted on the front surface of the body 10; and a plurality of color filters 70 contained inside the filter keeping case 60.

The body 10 has a rectangular solid shaped section, and the power source 100 is buried in the body 10. For the power source 100, a dry cell or a small-sized storage battery may be generally used. Preferably, three small-sized dry cells of 1.5V and AA size are connected in series.

The electric bulb 20, the reflection mirror 22 and the outer lid 30 are mounted on the upper end portion of the body 10 in order and in the perpendicular direction to the body 10. The outer lid 30 is screwed to the front end of the body 10 in order to prevent the electric bulb 20 and the reflection mirror 22 from being separated from the body 10. At this time, it is preferable that an inner transparent lid 32 may be disposed between the reflection mirror 22 and the outer lid 30. The inner lid 32 is screwed to the front end of the body 10, and the color filter 70 is mounted between the outer lid 30 and the inner lid 32 for sending a hand signal. The inner lid 32 maintains airtightness of the inside of the body 10, and allows for replacement of the color filter 70 even in the water.

At least one switch 40, preferably, two button-type switches 40 are mounted on the right side or the left side of the upper end portion of the body 10. So, when a user grasps the body 10 and turns the electric bulb 20 toward the front, the user's thumb or index finger is located on the switch 40, so that the user can very easily manipulate the signal.

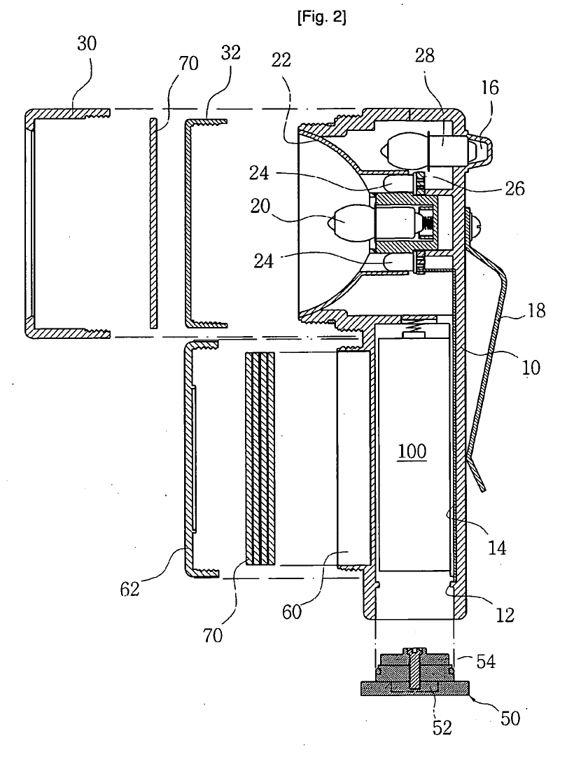

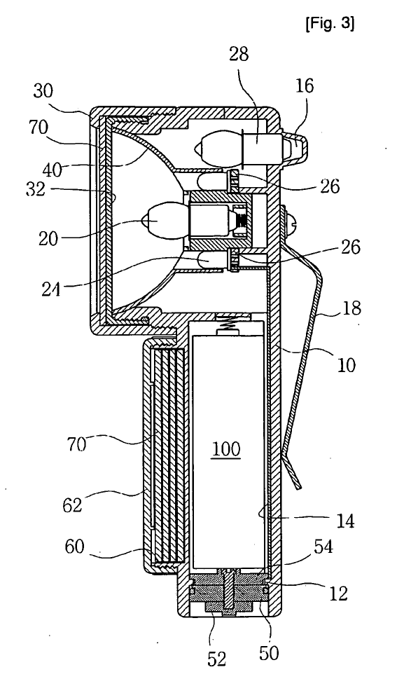

The lower lid 50 is mounted on the lower end of the body 10 in order to prevent the power source 100 from being separated outwardly. The lower lid 50 has a rectangular section like the body 10. When a rotational locking member 52 is rotated at an angle of 90° in a state where a conducting latch member 54 is opened as shown in FIG. 2, the conducting latch member 54 is locked to a stepped jaw 12 formed on the inner surface of the body 10 and connected with the body 10 as shown in FIG. 3. At this time, the conducting latch member 54 connects an electric wire 14, which is mounted on a side surface of the body in a longitudinal direction, to the lower end of the power source 100 so as to connect the power source 100 with the electric bulb 20.

In the present invention, the filter keeping case 60 is mounted on the front surface of the body 10. The filter keeping case 60 is of a cylindrical shape and has a filter cover 62. In case where the lantern is not used or used only as an illuminator, the color filters 70 are kept in the filter keeping case 60 in safe. The color filters 70 are disc-type semitransparent bodies of various colors. When the user sends a hand signal using the present invention, the color filter 70 of a wanted color is inserted between the outer lid 30 and the inner lid 32.

Meanwhile, the military lantern according to the present invention includes a plurality of satellite LED bulbs 24 mounted around the electric bulb 20. At this time, the satellite LED bulbs 24 are mounted on a PCB 26, and the electric bulb 20 and the satellite LED bulbs 24 are selectively controlled by the switch 40. The body 10 includes a spare bulb keeping recess 16 formed on the upper end of the inside thereof, and a spare bulb 28 which is used for emergency is kept inside the spare bulb keeping recess 16. The body 10 has a clip 18 mounted on the rear surface thereof, and so the user can easily hang the military lantern on a belt or military uniform.

A plurality of waterproof packing (not shown) are respectively mounted on the mounted portions of the inner lid 32, the switch 40, the lower lid 50 and the filter cover 62, so that the user can use the military lantern even in the rain or in the water.

While the present invention has been described with reference to the particular illustrative embodiment, it is not to be restricted by the embodiment but only by the appended claims. It is to be appreciated that those skilled in the art can change or modify the embodiment without departing from the scope and spirit of the present invention.

### INDUSTRIAL APPLICABILITY

As described above, the military lantern according to the present invention is very convenient in carrying since it has the size as small as it can be inserted into a pocket of military uniform and is lightweight, and provides improved illumination function and signal-sending function. Particularly, an adult can sufficiently grasp the lantern with h one hand. At this time, since the user's thumb or index finger is located on the switch of the lantern, he or she can easily manipulate the hand signal. Therefore, the military lantern according to the present invention may be used very efficiently not only for a military purpose but also for an industrial purpose or for leisure.

1. A military lantern comprising:
a body formed in a rectangular solid shape and having a power source buried therein;
an electric bulb, a reflection mirror and an outer lid mounted on the upper end portion of the body in a perpendicular direction to the body;
at least one switch mounted on the right side or the left side of the body;
a lower lid mounted on the lower end of the body;
a cylindrical filter keeping case mounted on the front surface of the body; and
a plurality of color filters contained inside the filter keeping case.

2. A military lantern according to claim 1, wherein the lower lid is connected with the body by rotation of a rotational locking member, and a conducting latch member connected to the rotational locking member connects an electric wire with the power source, the electric wire being connected to the electric bulb.

3. A military lantern according to claim 1, wherein an inner transparent lid is mounted between the reflection mirror and the outer lid.

4. A military lantern according to claim 1, wherein a plurality of satellite LED bulbs are mounted around the electric bulb.

5. A military lantern according to claim 1, wherein a spare bulb keeping recess is formed on the upper end of the inside of the body.
